(19) United States
(12) Patent Application Publication
(10) Pub. No.: US 2015/0055832 A1
(43) Pub. Date: Feb. 26, 2015

(54) METHOD FOR VIDEO DATA RANKING

(71) Applicant: Nikolay Vadimovich PTITSYN, Moscow (RU)

(72) Inventor: Nikolay Vadimovich PTITSYN, Moscow (RU)

(21) Appl. No.: 13/975,336

(22) Filed: Aug. 25, 2013

(51) Int. Cl. G06T 7/20; H04N 7/18

(52) U.S. Cl. CPC G06T 7/2006; H04N 7/181
USPC 382/107

(57) ABSTRACT

This Invention deals with data processing methods. This method involves the receipt of video data from a video camera and transmission of ranked video data to a user and/or to storage via communication links. Received live video data is first segmented based on at least one object and/or event; then, each segment is analyzed for characteristics that are critical for the priority estimate of a segment and/or used to search for segments in the storage. Each segment is prioritized based on its characteristics. Segments are ranked based on their priority estimates; the resulting priority queue of segments or one segment of the highest priority is transmitted to a user and/or recorded into storage. This Invention reduces load imposed on limited bandwidth communication links and improves video data processing without sacrificing video quality.

This Invention is about data processing in the field of closed-circuit security television (CCTV), video surveillance, and video analytics. This Invention enables users to implement efficient distributed video surveillance systems for various fields such as security, transportation, retail, sports, entertainment, utilities, and social infrastructure. This Invention can be used in local and global systems, dedicated and cloud-based servers. This Invention will substantially reduce costs related to video analysis, storage and transmission as well as expand VSaaS application.

One of the fundamental barriers impeding the development of distributed video surveillance systems is large amounts of data coming from cameras. Even if cutting-edge compression algorithms (such as H.264) are used, standard definition cameras (0.4 mega pixel) form data flow ranging from 0.5 to 5 Mbps while data flow formed by high-definition cameras (1-3 mega pixels) can reach 10 Mbps (in the HD video mode). This entails extremely high costs for multi-camera systems.

In particular, a substantial barrier to VSaaS development is the limited bandwidth of uplinks outside LAN. As of 2010, the global average Internet connection speed was reportedly 1.8 Mbps. If asymmetric access technologies (such as ADSL or cable modem) are used, the outbound channel from the subscriber to VSaaS application is four to ten-fold smaller than the inbound one. Generally, it is smaller than 512 Kbps. Thus, VSaaS is unable to provide viewing or recording video coming from large numbers of cameras, especially if these are HD cameras (over 1 mega pixel).

As disclosed in WO 2011041903 of Apr. 14, 2011 video analytics implemented on the video source's side i.e. embedded analytics can reduce amounts of data transmitted through communication links. However, such an approach does not adequately reduce amounts of data transmitted via communication links or archived in multi-camera systems, as well as large amounts of data recorded by video analytics. In highly-populated and busy areas does the video analytics form a continuous events flow. Therefore, amounts of transmitted data remain practically the same.

Another challenge is large amounts of alarm events transmitted to situation rooms and remote security panels. Operators often fail to respond to alarm events sent by the video surveillance system with analytics and are unable to focus on the most critical tasks.

Storage of large video data amounts requires high costs. Existing video storages (NVRs) use the following methods to improve the disk space usage: a) deleting old video records, including the function to manually lock the deletion of individual records (the lock function); b) reducing the video archive through higher compression rate. However, this affects video quality (spatial and time video detailing).

This Invention addresses the above problems.

This video data ranking method involves receipt of video data from at least one video camera and transmission thereof via communication links to at least one user and/or storage. It is characterized as follows: received live video data is segmented first, based on at least one object and/or event; then, each segment is analyzed for characteristics that are critical for the segment's priority and/or used for searching segments in the storage; then, each segment is prioritized based on its characteristics; then, segments are ranked according to their estimated priorities; and the resulting priority queue of segments or one highest-priority segment is transmitted via communication links to at least one user and/or storage.

The video segmentation process can use a motion detector.

The video segmentation process can use video analytics embedded into the network camera or video server.

The video segmentation process can use a server-based analytics.

The process of estimating the priority of each segment can use a regression function.

The regression function can be constructed based on the user's request statistics.

The process of estimating the priority of each segment can use a statistical classifier.

The statistical classifier can learn from the user's request statistics.

The process of estimating the priority of each segment can have user-defined rules.

The process of estimating the priority of each segment can use ongoing user requests.

The process of estimating the priority of each segment can be user-defined.

The process of estimating the priority of each segment can use the priority of camera that is the source of a given video segment.

The process of estimating the priority of each segment can use one feature determined by the video analytics such as object or event detection accuracy.

The priority estimation process can use the priority value pre-defined by a user in the table for objects or events of each type.

The segment priority estimation process can use the sum of or the maximum priority estimates for individual objects and/or events contained in a given segment.

The priority estimation process can use the data from external detectors.

A video segment can be a frame sequence.

A video segment can be an alarm frame or any part thereof.

A user shall be the video surveillance system operator.

The segment storage time can depend on the segment's priority.

When video is transmitted via limited bandwidth communication links highest-priority segments can be assigned first for transmission.

The resulting priority queue can be displayed in the user's interface.

Segments of the resulting priority queue can be displayed in the user's interface in color or using any other graphic symbol that depends on the segment priority.

Actions used to attract the operator's attention can include: a sound alarm and/or SMS-message depending on the estimated priority.

Each segment within the priority queue can be transmitted as a single file.

The priority queue can be distributed among a number of users.

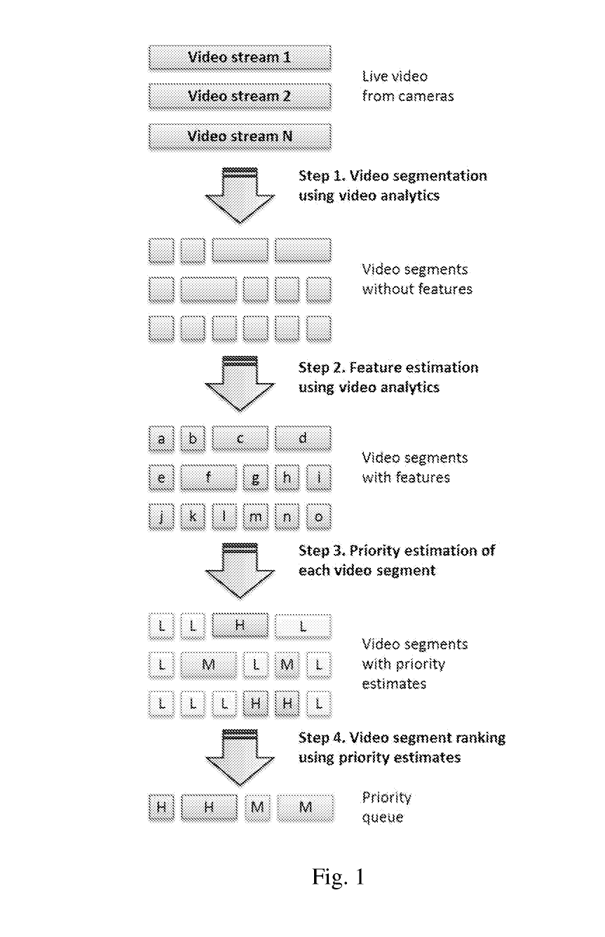

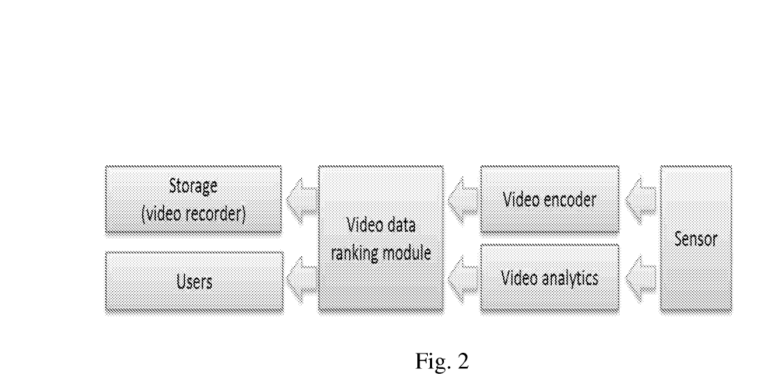

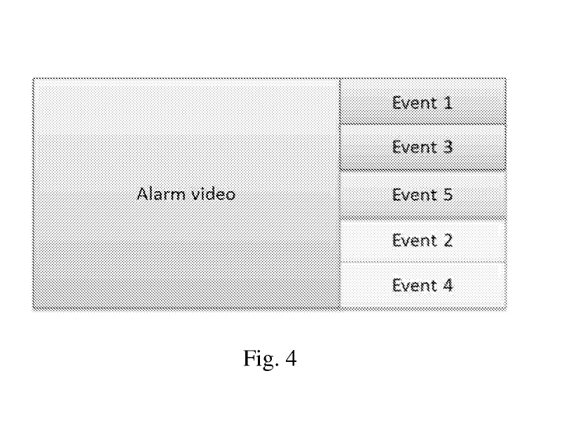

FIGS. 1-4 provide explanations to this Invention. FIG. 1 shows the general diagram of the method for video data ranking. FIG. 2 shows the video surveillance system diagram. FIG. 2 outlines the user graphic interface. Video segments are colored and shown in the chronological order. FIG. 4 outlines the user graphic interface. Video segments are colored and shown in the order of priority.

The method for video data ranking includes the following steps shown in FIG. 1:

Step 1. Live Video Segmentation Using Video Analytics

Live video coming from surveillance cameras is segmented. A segment can be either a frame sequence or an individual frame (alarm frame) or its part. Video is segmented in such a way that each segment corresponds to one object or event that is subject to camera surveillance and is of interest for a user. One segment can contain a number of objects if such objects appear simultaneously.

The video segmentation process can use various video detectors, for instance, motion detectors; people face detectors; car license plate detectors; fire detectors; etc. We recommend using object tracking algorithms so that segments are completed after a detected object has gone. Automated recognition of pre-defined events, for instance, tripwire, loitering or left thing is also possible.

Examples of segments include: a) a persons' face separated from the video flow; b) an alarm frame showing a person appearing in the Sterile Zone; c) a video record showing a car driving against the red light.

It is reasonable to limit the segment size to reduce the time required to transmit the highest-priority segments via limited bandwidth communication links and to improve the use of a video storage.

One segment can contain a number of objects or events, in particular at highly-populated and busy areas.

Step 2. Segment Feature Estimation

Each segment has its characteristics estimated which are critical for the segment's priority and/or can be used to search for segments in the storage. Table 1 contains examples of characteristics that can be used in this Invention.

TABLE 1

| Feature Category | Example of characteristics |
|---|---|
| Date and time | Segment's start date and time |
| | Segment's end date and time |
| | Segment duration |
| Location | Camera's identifier and priority |
| | Object detection zone's identifier and priority |
| Objects | Presence of objects of a defined type (class) |
| | Number of objects |
| | Estimated object detection accuracy |
| Events | Adherence/non-adherence to a pre-defined rule |
| | (entering/quitting the zone; stopping; loitering; |
| | etc.) |
| | Fire/smoke detection |
| | Lost signal; global changes within the |
| | camera's coverage area; blacked-out image caused |
| | by switched-off lighting or camera diaphragm |
| | failure. |
| External sensors | The state of additional sensors embedded into |
| | the video surveillance system (sound sensors, door |
| | sensors, fire/gas alarm sensors, etc.) |
| User requests | The number of video surveillance system users |
| | that requested the segment |
| | Request time/relevance |

As shown in FIG. 1, low-case letters are assigned to segment characteristics: a, b, c . . . .

Step 3. Priority Estimation of Each Segment

Each segment's priority can be estimated either on an automated basis using a formal or empiric technique or on a manual basis.

The following formal priority estimation techniques are worth mentioning:

a. Regression Function. The priority and feature of a segment are assumed to be dependent variables. The priority of a segment depends on the segment's feature as follows: q=f(x) where f stands for the regression function defining how the priority of segment q depends on vector x that contains characteristics of the fragment or an object in the segment. The segment priority q can take continuous values, for instance, from 0 (the lowest priority) to 1 (the highest priority). Such well-known methods as Linear Regression or Support Vector Machine can be used to construct the regression function.

b. The Statistical Classifier determines the priority of a segment based on the segment's characteristics as follows: q=C(x) where q stands for the segment's priority, C stands for the statistical classifier, and x stands for the vector containing characteristics of the fragment or an object in the segment. The classifier yields discrete values of q, for instance, 1 (low priority), 2 (medium priority), and 3 (high priority). Such well-known classifiers as SVM, k-NN or Boosting are possible.

Under the above formal approaches the regression function can be constructed or the classifier can be instructed: a) during the video surveillance system configuration process; and/or b) on a continuous basis during the system operation in order to record events and user's actions statistics.

As shown in FIG. 1, capital letters are assigned to segment priorities as follows: H (High), M (Medium), and L (Low).

The following empiric priority estimation techniques are worth mentioning:

a. Trivial Estimation by One Feature: q=x or q=−x where x stands for the segment's feature such as object detection accuracy, number of objects detected, and the object-camera distance.

b. Priority Table: q=Q[x] where x stands for the type of an event or object in the segment determined by the video analytics; Q stands for the priority lookup table determining the segment priority for each type of an event or object. Table 2 shows the priority table example.

Where a segment contains multiple objects or events, characteristics of each object or event can be aggregated to produce an integral priority estimate using such functions as sum or maximum. For instance, q=Σᵢpᵢqᵢ/Σᵢpᵢ or q=maxᵢpᵢqᵢ where pᵢ stands for detection accuracy for an object or event in the video segment; qᵢ stands for the priority of i object or event determined based on the lookup table, and i=1,2, . . . stands for the number of an object or event. Should the video analytics algorithm provide no accuracy values, it is assumed that pᵢ=1.

A user can at his/her discretion change the priority of each segment to manage the time of video segment storage or segment transmission via limited bandwidth links.

TABLE 2
Priorities Assigned to Typical Events

| Event | Recommended priority qᵢ |
|---|---|
| Fire/smoke detection | 1.0 |
| Fence trespassing | 1.0 |
| A person approaching secured | 1.0 |
| premises outside working hours | |
| Lost signal, distorted video signal, | 1.0 |
| substantial changes in the camera's | |
| coverage area | |
| A person leaving secured premises | 0.5 |
| Loitering at the parking arrangement | 0.5 |
| Left thing | 0.5 |
| Motion detector alarm | 0.2 |
| Running person | 0.2 |
| Crowd accumulation | 0.2 |
| Person walking around | 0.1 |
| secured premises during working | |
| hours | |

Cameras or object/even detection zones can also have a priori priorities assigned. In this case, the priority calculation formula will be as follows: q=qₛf(x) where qₛ stands for the priority of an event source (the priority of a camera or a surveillance zone).

Step 4. Video Segment Ranking using Priority Estimates

Step 4 involves ranking of all segments using priority estimates in order to process higher priority data on a first priority basis. Ranked segments are added to the data structure called the priority queue. The ranking subcase is to search for one segment of the highest priority.

For instance, a fire detection video segment has higher priority than a video segment showing a person appearing in front of the door. Such a segment is transmitted via communication links, shown to the operator and recorded into the storage on a first priority basis.

Lower priority video segments can undergo no further processing; however, they can be recorded in the local storage to be available at the user's request. Such lower-priority segment screening substantially reduces load imposed on the communication links, storage, and the operator.

As far as new data (live video) arrives, Steps 1-4 are repeated.

Thus, this Invention ensures efficient data transmission though priority-based transmission of the most important data rather than sacrificing the video quality. The priority of video segment or frame's part transmission is based on the video analytics output and/or user's requests.

The best closest analogues record video using motion detectors and transmit video segments irrespective of their priority or continuously transmit video. This rapidly exhausts disk space in the data storage and/or bandwidths. In addition, closest analogues do not rank data for the operator which increases the required number of operators in monitoring centers.

FIG. 2 shows one of possible applications of this Invention. Non-compressed video comes from the sensor (camera) to the video encoder and video analytics module. The video encoder compresses video using, for instance, H.264 algorithm. The video analytics model forms metadata describing objects or events in the video. The ranking module implements this Video Data Ranking Methods in 4 steps as follows: a) segments compressed video based on the metadata produced by the video analytics; b) estimates characteristics of each segment; c) estimate the priority of each segment using its characteristics; and d) ranks (sorts) all segments using priority estimates. Ranked video data are transmitted to users (operators) and recorded in the storage.

This Invention can find its application as part of local or distributed video surveillance system. The video data ranking module can be: a) embedded in the video transmitter (network camera or network video server); b) located on the video receiver (server) or c) distributed between the video transmitter and receiver.

The ranked transmission method can be implemented based on software modules embedded into such system components as network camera, network video server, NVR, VMS and online video surveillance system. In addition, such software modules can run on work stations, dedicated servers, processing centers or cloudy hosting.

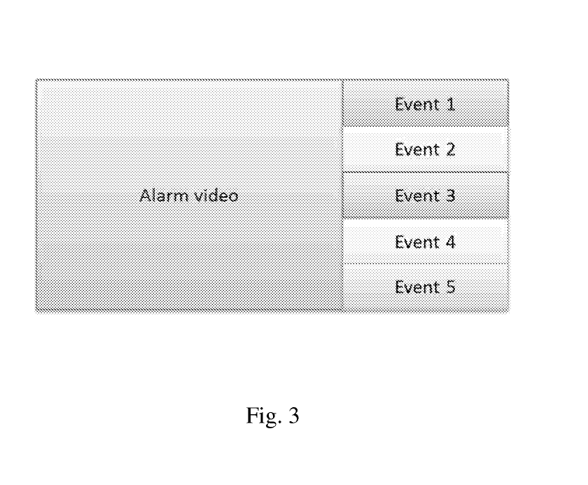

According to this Invention, priority estimates for video data segments are used to color-highlight (FIG. 3-4) or rank segments at the workstation of the video surveillance system user/operator in order to show higher-priority segments in the order of priority (FIG. 4). For instance, alarm videos can either be simply displayed or sorted in the descending order of priority. This substantially improves the video surveillance system user/operator's performance as he/she focuses on the most critical objects and events (FIG. 4).

Priority estimates can either be highlighted in color or shown using any other graphic symbols (digits, lines, circles, ticks) similar to the signal level or battery charge indications typical of consumer devices.

The user interface displaying ranked video data can either be based on special-purpose software or web technologies such as HTML5 or Flash.

In addition, video segment priority segments can also be used to manage video storage. Recurrent video recording into storage involves the task of deleting old segments. According to this Invention, segments are deleted based on their priority estimates: segments of lowest priority will be first to be deleted. Storage time of each video segment can be calculated using the formula as follows: t=t₀q where t₀ stands for the basic (maximum) data storage time, for instance, 30 days, and q stands for the segment's priority within the range of [0,1]. Therefore, this Invention improves storage by means of storing of the most critical information.

This Invention suits various video transmission modes such as: a) continuous transmission at a constant speed (maximum amounts of video data are transmitted through the dedicated bandwidth); continuous transmission at a variable speed (higher-priority video data are transmitted as far as they occur); batch transmission (at the user's request and when video transmitter/receiver connection is alive).

This Invention ensures transmission of the most critical video data after the video transmitter/receiver connection has failed and then resumed.

This Invention can be used for ranked transmission of alarm video with video data reflecting alarm events be optionally uploaded at the user's request or in the delayed mode (for instance, at night where the communication link load is lower).

In addition to live real-time video (continuous video flow) coming from camera, this video data ranking method suits also archived video recorded into storage (post processing).

This video data ranking method suits video surveillance systems based on standards and/or guidelines adopted by the Open Network Video Interface Forum, (ONVIF, www.onvif.org) or the Physical Security Interoperability Alliance (PSIA, psiaalliance.org). In particular, priority estimates can be transmitted within metadata, messages and/or events according to ONVIF and/or PSIA standards. Video segments can be transmitted according to ONVIF and/or PSIA standards.

Video segments can also be transmitted as files of different formats such as TS, M2TS, MKV, OGV, MP4, AVI, etc.

This video data ranking method can be used to implement two strategies as follows: a) process all video data or events having a priority above a predefined level with minimum resource consumption (including operators, communication links, storage space); b) process maximum amounts of video data or events with highest priorities with limited resources as defined. In practice, a hybrid strategy finds frequent application combining the above options (a) and (b). The resource consumption varies depending on alarm events within the established limits.

1. This video data ranking method involves the receipt of video data from at least from one video camera or sensor and transmission of ranked video data via communication links to at least one user and/or storage. It is characterized as follows: received live video data is first segmented based on at least one object and/or event; then, each segment is analyzed for characteristics that are critical for the segment's priority and/or used for searching segments in the storage; then, each segment is prioritized based on its characteristics; then, segments are ranked according to their estimated priorities; and the resulting priority queue of segments or one highest-priority segment is transmitted via communication links to at least one user and/or storage.

2. Method of claim 1 wherein video data is segmented based on a motion detector.

3. Method of claim 1 wherein video data is segmented based on video analytics embedded into a network camera or video server.

4. Method of claim 1 wherein video data is segmented based on a server-based video analytics.

5. Method of claim 1 wherein each segment is prioritized based on the regression function.

6. Method of claim 5 wherein the regression function is constructed based on the user's request statistics.

7. Method of claim 1 wherein each segment is prioritized using the statistical classifier.

8. Method of claim 7 wherein the statistical classifier is instructed based on the user's request statistics.

9. Method of claim 1 wherein each segment is prioritized based on user-defined rules.

10. Method of claim 1 wherein each segment is prioritized based on ongoing user's requests.

11. Method of claim 1 wherein each segment is prioritized manually by a user.

12. Method of claim 1 wherein each segment is prioritized based on the priority of a camera that is the source of the video segment.

13. Method of claim 1 wherein each segment is prioritized based on one feature determined by video analytics such as object/event detection accuracy.

14. Method of claim 1 wherein each segment is prioritized based on the priority value pre-defined by a user in a table for each type of an object or event.

15. Method of claim 1 wherein the segment priority estimation process can use the sum of or the maximum priority estimates for individual objects and/or events contained in a given segment.

16. Method of claim 1 wherein the priority estimation process uses data received from external sensors.

17. Method of claim 1 wherein a video segment is a frame sequence.

18. Method of claim 1 wherein a video segment is an alarm frame or any part thereof.

19. Method of claim 1 wherein a user is a video surveillance system operator.

20. Method of claim 1 wherein storage time of a segment recorded into storage depends on the segment's priority.

21. Method of claim 1 wherein the highest-priority segments are assigned first for transmission via limited bandwidth communication links.

22. Method of claim 1 wherein the resulting priority queue is displayed at the user interface as the list of resulting segments and segment indications.

23. Method of claim 1 wherein segments or their indications in the resulting priority queue are displayed at the user interface in color or using any other graphic symbols depending on the segment priority.

24. Method of claim 1 wherein actions required to attract the operator's attention depend on the segment's priority estimate and include a sound alarm and/or SMS-message.

25. Method of claim 1 wherein each segment in the priority queue is transmitted as a single file.

26. Method of claim 1 wherein the priority queue is distributed among a number of users.
